(19) United States
(12) Patent Application Publication
(10) Pub. No.: US 2008/0040711 A1
(43) Pub. Date: Feb. 14, 2008

(54) METHODS AND APPARATUS TO OPTIMIZE COMPUTER INSTRUCTIONS

(76) Inventors: Xiaofeng Guo, Shanghai (CN); Jinquan Dai, Shanghai (CN); Long Li, Shanghai (CN)

Correspondence Address: HANLEY, FLIGHT & ZIMMERMAN, LLC, 150 S. WACKER DRIVE, SUITE 2100, CHICAGO, IL, 60606, US

(21) Appl. No.: 11/537,931

(22) Filed: Oct. 2, 2006

Related U.S. Application Data
(63) Continuation of application No. PCT/CN06/02006, filed on Aug. 8, 2006.

(51) Int. Cl. G06F 9/45

(52) U.S. Cl. 717/161

(57) ABSTRACT

Methods and apparatus to optimize computer instructions are disclosed. An example method includes receiving a set of computer instructions, determining a first location of a first computer instruction that indicates the end of a critical section in the set of computer instructions, and modifying the execution order of the set of computer instructions to cause the first computer instruction to be executed earlier than the first location. In an example implementation, the disclosed methods and apparatus may be used to optimize the performance of computer instructions executing on multi-processing computer systems.

### RELATED APPLICATIONS

This patent arises from a continuation of International Patent Application No. PCT/CN2006/002006, entitled “METHODS AND APPARATUS TO OPTIMIZE COMPUTER INSTRUCTIONS”, which was filed on Aug. 8, 2006. International Patent Application No. PCT/CN2006/002006 is hereby incorporated by reference in its entirety.

### FIELD OF THE DISCLOSURE

This disclosure relates generally to software processes and, more particularly, to multi-threaded software processes.

### BACKGROUND

The desire to increase the execution speed of computer instructions has lead to the implementation of parallel processing systems. Parallel processing systems include multiple processing units and/or multiple cores on each processing unit. Each processing core can execute computer instruction simultaneously. In addition, processes have been divided into multiple threads such that multiple threads can be executed simultaneously.

In parallel processing systems, care must be taken to ensure that data used by one thread is not changed by another thread, a shared resource is not accessed simultaneously, etc. Critical section labels are used to prevent such an occurrence. A processing system can only execute one critical section of code at a time. Thus, the use of critical sections can prevent simultaneous access to data and resources.

In general, a first processor executes the first critical section of a first thread. A second processor may execute a non-critical section of another thread. After the critical section has ended, the first thread notifies the system of the completion of the critical section and the system performs a context switch to begin executing a critical section of the next available thread. However, the critical section of the next available thread may not be executed immediately because of notification latency. Rather, the first processor may execute a non-critical section of another thread until the notification of the end of the critical section of the first thread is received.

### BRIEF DESCRIPTION OF THE DRAWINGS

FIG. 1 is a block diagram of an example system 100 for optimizing compiled software instructions.

FIG. 2 is an illustration of an example execution of instructions that have been optimized by the example system of FIG. 1.

FIG. 3 is a flowchart representative of an example process that may be performed to implement the example system of FIG. 1.

FIG. 4 is a flowchart representative of an example process that may be performed to hoist CSend instructions.

FIG. 5 illustrates an example flow diagram for a set of instructions, an equation set for a dataflow analysis, and a table showing the results of the dataflow analysis performed on the flow diagram.

FIG. 6 is a flowchart representative of an example process that may be performed to verify the correctness of CSend hoisting.

FIG. 7 is a flow diagram illustrating the result of the process of FIG. 3 applied to the flow diagram of FIG. 5.

FIG. 8 is a block diagram of an example computer 800 the may execute machine readable instruction that implement the processes of illustrated in FIGS. 3, 4, and 6.

### DETAILED DESCRIPTION

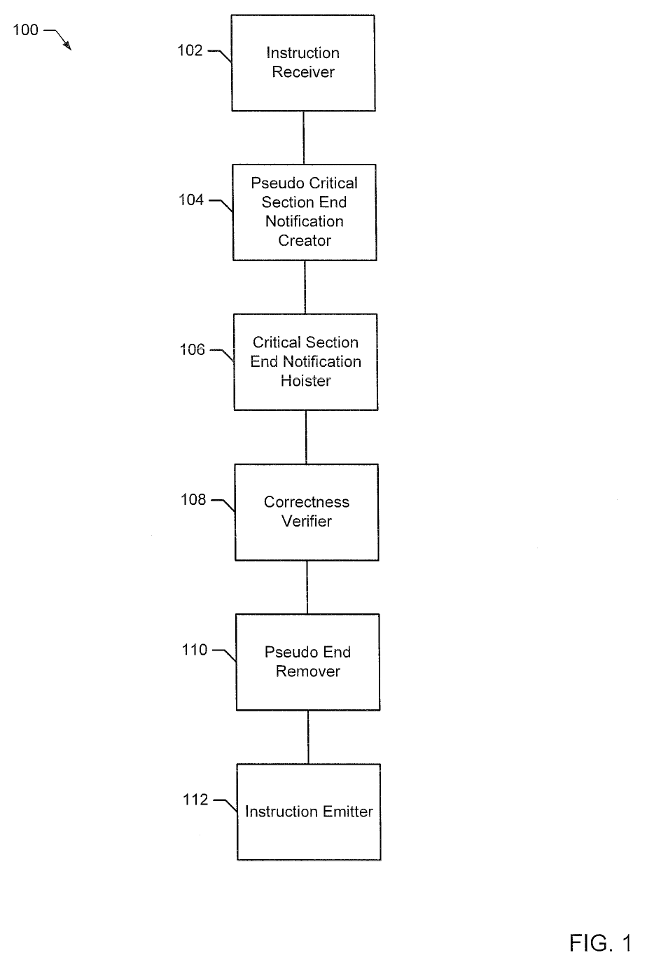

FIG. 1 is a block diagram of an example system 100 for optimizing compiled software instructions. For example, the methods and apparatus disclosed herein may be used as part of an implementation of a software compiler. In general, the example methods and apparatus described herein may be used to cause instructions indicating the end of a critical section of instructions (CSend) to be moved to an earlier execution location in the compiled instructions (i.e., the execution order is changed). In an example implementation, a place-holder (a pseudo CSend (pCSend)) is inserted at the initial location of a CSend. Next, the CSend is moved to an earlier location in the execution order. Then, the modifications are verified to ensure that the modifications do not affect the logic of the software instructions. If the logic has been affected, the incorrect CSends are removed and the associated pCSends are replaced with CSends. Finally, all remaining CSends are removed and the code is emitted from the compiler. The disclosed methods and apparatus may be used to optimize the performance of computer instructions executing on multi-processing computer systems.

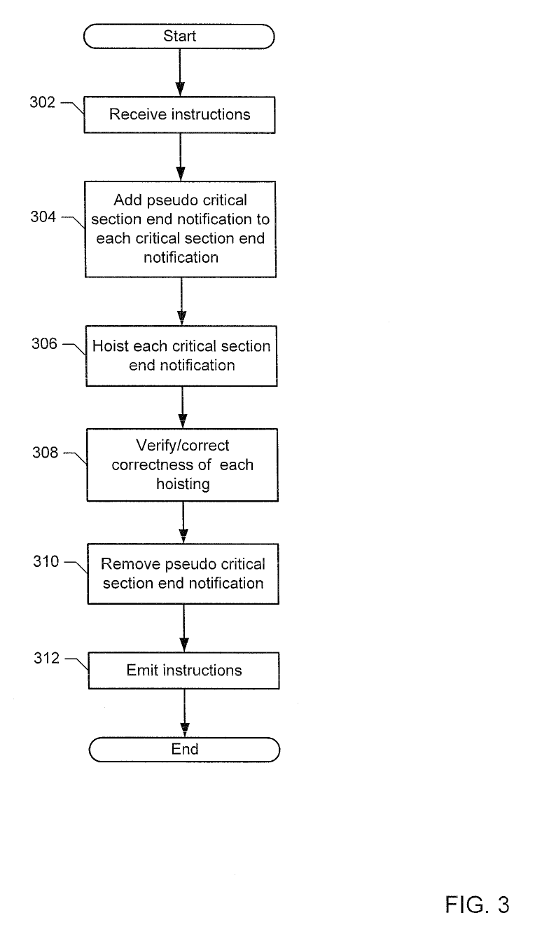

The example system 100 comprises an instruction receiver 102, a pseudo critical section end notification (pCSend) creator 104, a critical section end (CSend) notification hoister 106, a correctness verifier 108, a pCSend remover 110, and an instruction emitter 112. An example method to implement the example system 100 is illustrated in FIG. 3 and is described in further detail below.

In the illustrated example, the instruction receiver 102 receives a set of instructions that are to be optimized and passes them to the pCSend creator 104. The example instruction receiver 102 receives the set of instructions from a compiler that is associated with the example system 100. However, the instruction receiver 102 may receive the set of instructions from any source such as, for example, a file, a user input, data stored in a memory, etc. Before the set of instructions is received by the example instruction receiver 102, other operations and/or optimizations may be applied to the instructions such as, for example, loop optimizations. The instruction receiver 102 may not be included in an implementation of the example system 100 in which the methods and apparatus disclosed herein are integrated with a compiler.

The example pCSend creator 104 iterates through the set of instructions received from the instruction receiver 102, inserts a pCSend instruction in the set of instructions, and passes the set of instructions to the CSend hoister 106. In the illustrated example, the pCSend instruction is inserted in the set of instructions on a line after the CSend instruction. Alternatively, the pCSend instruction may be inserted on a line before the CSend instruction. The inserted pCSend instruction can be used to prevent instructions in the critical section from being moved to a location outside of the critical section. In addition, the pCSend instruction can prevent other instructions from being moved into the critical section as the CSend instruction is hoisted by the CSend hoister 106. Also, the pCSend instruction can be used by the correctness verifier 108 to indicate the original location of the CSend instruction. The pCSend instruction may not be needed in all implementations. For example, the original location of CSend instructions may be stored as a variable in memory. Additionally, a pCSend instruction may not be inserted at all instances of CSend instructions. For example, pCSend instructions may be inserted based on the performance of the instructions on traces. Any iteration algorithm may be used to insert pCSend instructions.

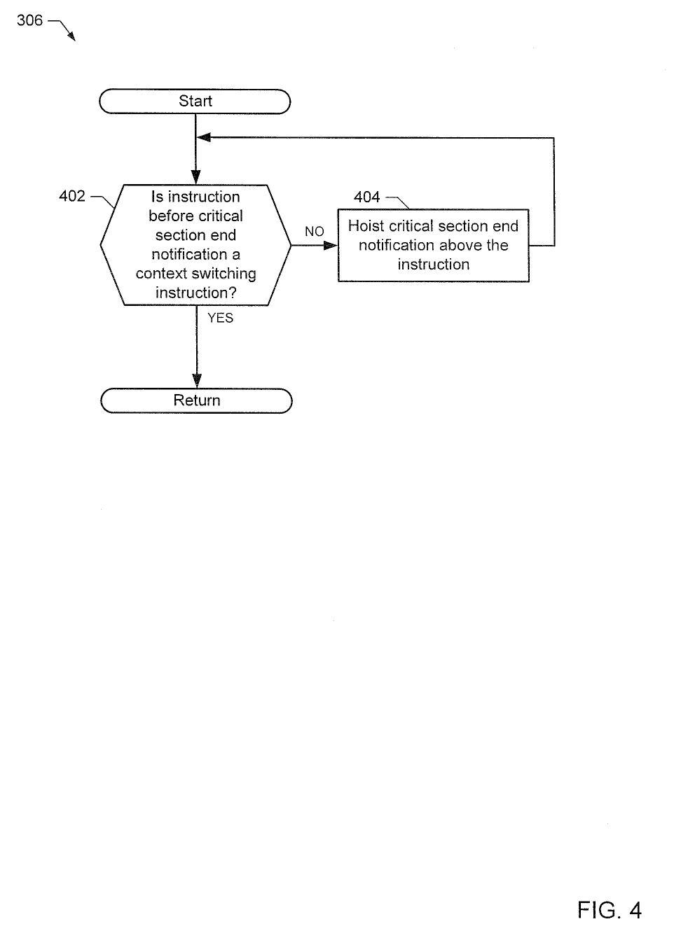

The example CSend hoister 106 moves CSend instructions to earlier locations (i.e., modifies the execution order) in the set of instructions and passes the set of instructions to the correctness verifier 108. Modifying the execution order to cause the CSend instructions to execute earlier may compensate for notification delays that cause delays between the executions of critical sections of threads. The CSend hoister 106 of the illustrated example moves the CSend instruction to the earliest location in the critical section that is not earlier than an instruction that may invoke a context switch (e.g., wait instructions, context switch requests, blocking instructions, stalling instructions, etc.). An example method to implement the CSend hoister 106 is illustrated in FIG. 4 and is described in further detail below. However, any method of causing the CSend instruction to be located earlier in the execution order of set of instructions may be used. For example, methods that utilize code scheduling, code motion, and other code optimization techniques may be used.

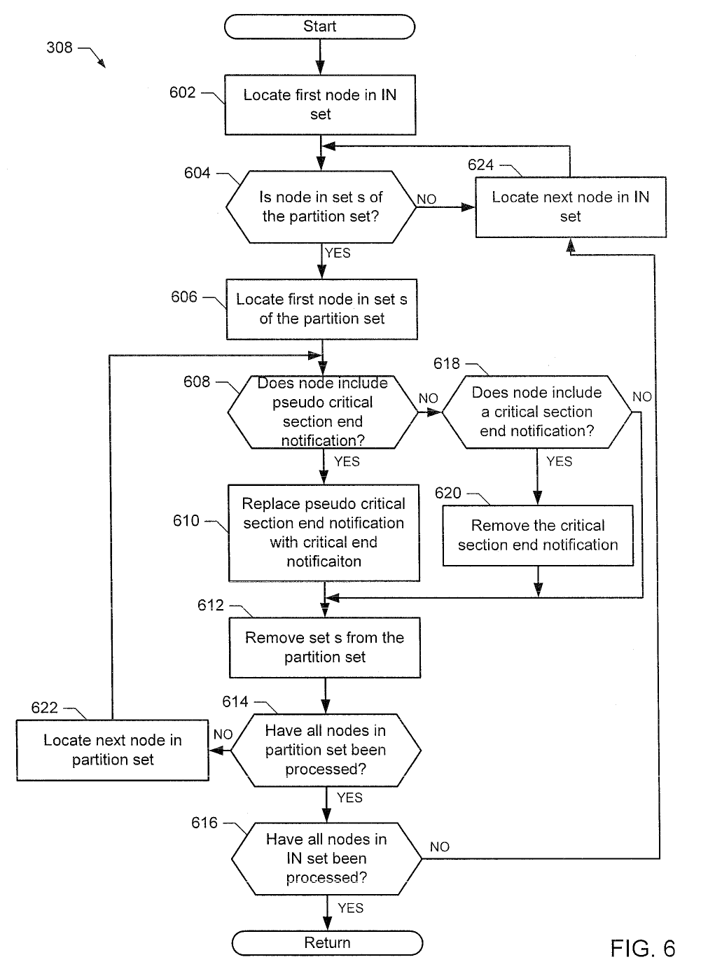

The example correctness verifier 108 iterates through the CSend instructions in the set of instructions received from the CSend hoister 106 and reverses the hoisting of the CSend instruction where the hoisting has altered the logic of the set of instructions. An example method for implementing the correctness verifier 108 of the illustrated example is illustrated in FIG. 6 and is described in further detail below. However, any algorithm for verifying the correctness of the CSend hoisting may be used. The correctness verifier 108 passes the verified set of instructions to the pCSend remover 110.

The example pCSend remover 110 removes any pCSend instructions that remain after the correctness verifier 108 has verified the set of instructions. The pCSend remover 110 may not be included in the example system 100 if the pCSend instructions are merely used as placeholders, which will be ignored during execution of the set of instructions. The modified set of instructions is passed to the instruction emitter 112.

The instruction emitter 112 of the illustrated example emits the set of instructions following the optimization performed by the example system 100. For example, the instruction emitter 112 may output the set of instructions as machine code, as the same type of instructions as the set of instructions, as instructions of a type that is different than the set of instructions, etc. The instruction emitter 112 may be integrated with the code of a compiler in which the example system 100 is integrated.

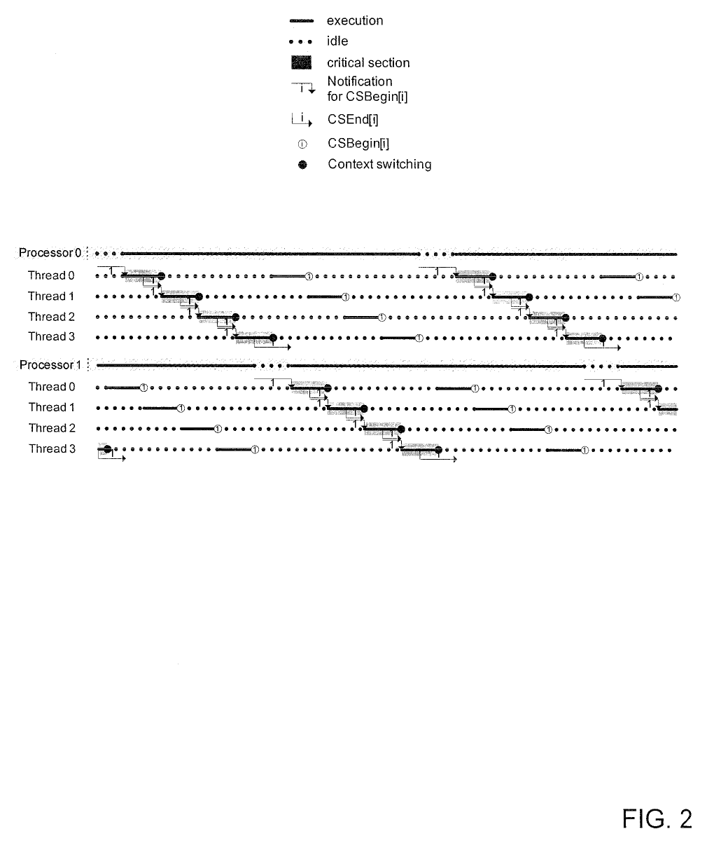

FIG. 2 is an illustration of an example execution of instructions that have been optimized by the example system 100 of FIG. 1. In example execution, the CSend notifications are sent near the middle of the execution of the critical section, rather than at the end of the execution of the critical section. Accordingly, the CSend notification is received in time to allow the next critical section to be executed next. For example, the critical section of Thread 1 on processor 1 is executed at the time that Thread 0 signals for a context switch. Of course, delays in notification of the context switch may cause delays in performing the next critical section execution.

Having described the architecture of an example system that may be used to optimize computer instructions, various processes are described in FIGS. 3, 4, and 6. Although the following discloses example processes, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. Additionally, some portions of the process may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

FIG. 3 is a flowchart representative of an example process that may be performed to implement the example system 100 of FIG. 1.

The example process begins when the instruction receiver 102 receives a set of instructions to be optimized (block 302). The pCSend creator 104 then inserts a pCSend instruction on the line after each CSend instruction in the set of instructions (block 304). Then, the CSend hoister 106 moves each of the CSend instructions in the set of instructions to earlier locations in the execution order of the set of instructions (block 306). An example method for hoisting the CSend instructions is illustrated in FIG. 4.

Next, the correctness verifier 108 verifies the correctness of the movement of each CSend instruction in the set of instructions and corrects any errors (block 308). An example method for verifying the correctness of the movement of the CSend instructions is illustrated in FIG. 6. Then, the pCSend remover 110 removes any remaining pCSend instructions (block 310). Finally, the instruction emitter 112 emits the set of instructions (block 312).

FIG. 4 is a flowchart representative of an example process that may be performed to hoist CSend instructions (block 306 of FIG. 3). The example process 306 may be repeated for each of the CSend instructions in the set of instructions. Alternatively, the example process 306 may be performed simultaneously for each CSend instruction.

The example process 306 first determines whether the instruction prior to the current CSend instruction is a context switching instruction (e.g., wait instructions, context switch requests, blocking instructions, stalling instructions, etc.) (block 402). If the instruction prior to the current CSend instruction is a context switching instruction, process 306 is complete and control proceeds to block 308 of FIG. 3.

If the instruction prior to the current CSend instruction is not a context switching instruction, the CSend instruction is moved to the line before to the prior instruction (block 404). The control proceeds to block 402 to analyze the instruction that is prior to the new location of the CSend.

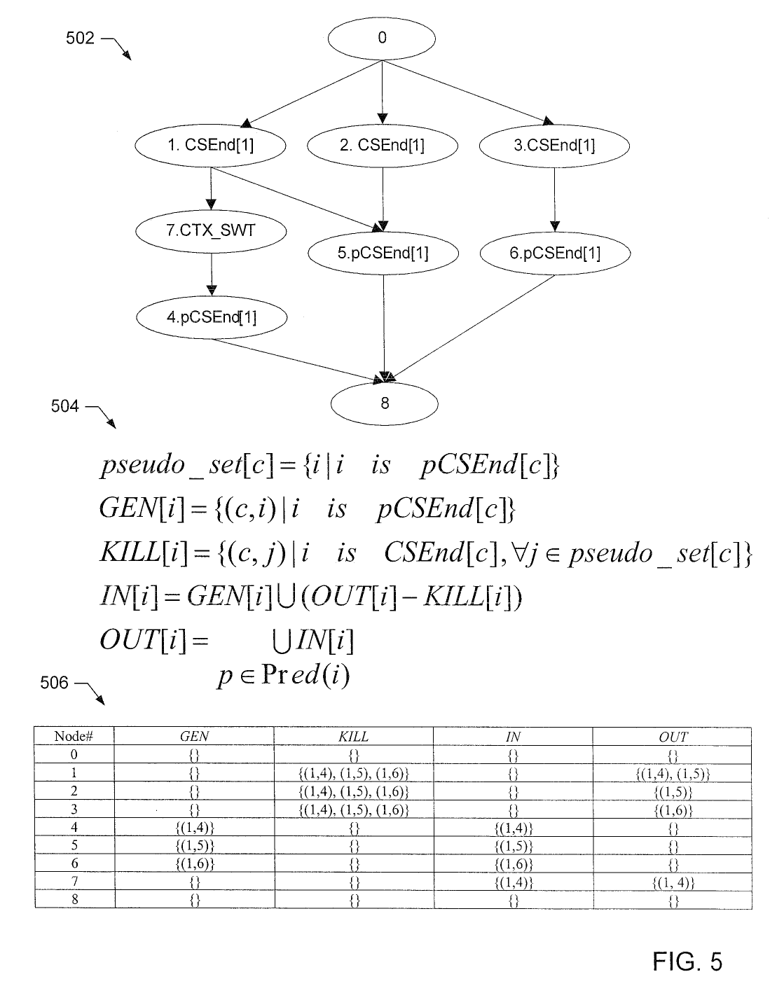

FIG. 5 illustrates an example flow diagram 502 for a set of instructions, an equation set 504 for a dataflow analysis, and a table 506 showing the results of the dataflow analysis performed on the flow diagram 502. The results shown in the table 506 are used by the process illustrated in FIG. 6.

In the flow diagram 502, nodes 1, 2, and 3 include CSend instructions that have been hoisted by the CSend hoister 106. Nodes 4, 5, and 6 include pCSend instructions that have been added by the pCSend creator 104. Node 7 includes a context switching instruction (CTX_SWT).

The pseudo_set[c] in the equation set 504 includes the nodes of all of the instructions corresponding to the critical section to be analyzed. The GEN[i] set includes all of the nodes that give the definitions generated by node i where node i includes a pCSend instruction. The KILL[i] set includes all of the nodes that change the definitions of node i where node i includes a CSend instruction and every j is in the pseudo_set[c] set. The IN[i] set includes all of the nodes that have definitions that exist at the start of node i. The OUT[i] set includes all of the nodes that have definitions that reach the end of node i.

The table 506 illustrates the results of applying the equation set 504 to the flow diagram 502. Using the table it can be found that the mappings of CSend to pCSend are: node 3 to node 6, node 2 to node 5, node 1 to node 4, and node 1 to node 5 based on the OUT[i] sets. Accordingly, the set of CSend to pCSend includes node 1, node 2, node 3, node 4, node 5, and node 6. Based on the set of CSend to pCSend, an initialized partition set is {{1} {2} {3} {4} {5} {6}}. The following table shows the effect of each of the CSend to pCSend mappings on the partition set:

| Mapping | Partition Sets |
|---|---|
| 3→6 | {{1} {2} {3 6} {4} {5}} |
| 2→5 | {{1} {2 5} {3 6} 4} |
| 1→4 | {{1 4} {2 5} {3 6}} |
| 1→5 | {{1 2 4 5} {3 6}} |

Accordingly, the completed partition set is {{1 2 4 5} {3 6}}. The table 506 indicates that node 4 includes the pCSend related to node 7 (i.e., because IN[7]={(1,4)}). The partition set including node 4 and corresponding to node 7 is {1 2 4 5). This partition set is used by the process illustrated in FIG. 6.

FIG. 6 is a flowchart representative of an example process that may be performed to verify the correctness of CSend hoisting (block 308 of FIG. 3). The process 308 may be executed for each CSend instruction in an instruction set or may be executed for a subset of CSend instructions. For example, the process 308 may only before performed for CSend instructions that have been moved. In the illustrated example, the process 308 is performed by the correctness verifier 108 of FIG. 1. Alternatively, the process 308 may be performed by any other component of an example system.

Process 308 begins by locating the first node in the IN[i] set corresponding to the CSend instruction that is to be verified (block 602). Then, the correctness verifier 108 determines if the located node is in one of the sets of the partition set corresponding to the instructions (e.g., the partition set determined for the flow diagram 502 of FIG. 5) (block 604). If the located node is not in the partition set, the correctness verifier 108 locates the next node in the IN[i] set (block 606) and control proceeds to block 604.

If the located node is in one of the sets (referred to as set s) of the partition set (block 604), the correctness verifier 108 locates the first node in the partition set (referred to as the partition set node) (block 606). The correctness verifier 108 then determines if the partition set node includes a pCSend instruction (block 610). If the partition set node does not include a pCSend instruction, control proceeds to block 618.

If the partition set node includes a pCSend instruction (block 610), the correctness verifier 108 replaces the pCSend instruction with a CSend instruction. Control then proceeds to block 614.

If the partition set node does not include a pCSend instruction (block 610), the correctness verifier 108 determines if the partition set node includes a CSend instruction (block 618). If the partition set node does not include a CSend instruction, control proceeds to block 612. If the partition set node includes a CSend instruction, the correctness verifier 108 removes the CSend instruction (block 620). Control then proceeds to block 612.

After replacing the pCSend instruction with a CSend instruction (block 610), determining that the partition set node does not include a CSend (block 618), or removing the CSend instruction (block 620), the correctness verifier 108 removes set s from the partition set (block 612).

The correctness verifier 108 then determines if all partition set nodes have been processed (block 614). If there are further partition set nodes to be processed, the correctness verifier 108 locates the next partition set node (block 622) and control proceeds to block 608 to process the next node.

If there are no further partition set nodes to be processed, the correctness verifier 108 determines if there are further nodes in the IN[i] set to be processed. If there are further nodes in the IN[i] set to be processed, the correctness verifier 108 locates the next node in the IN[i] set (block 624) and control proceeds to block 604 to process the next node. If there are no further nodes in the IN[i] set to process, control proceeds to block 310 of FIG. 3.

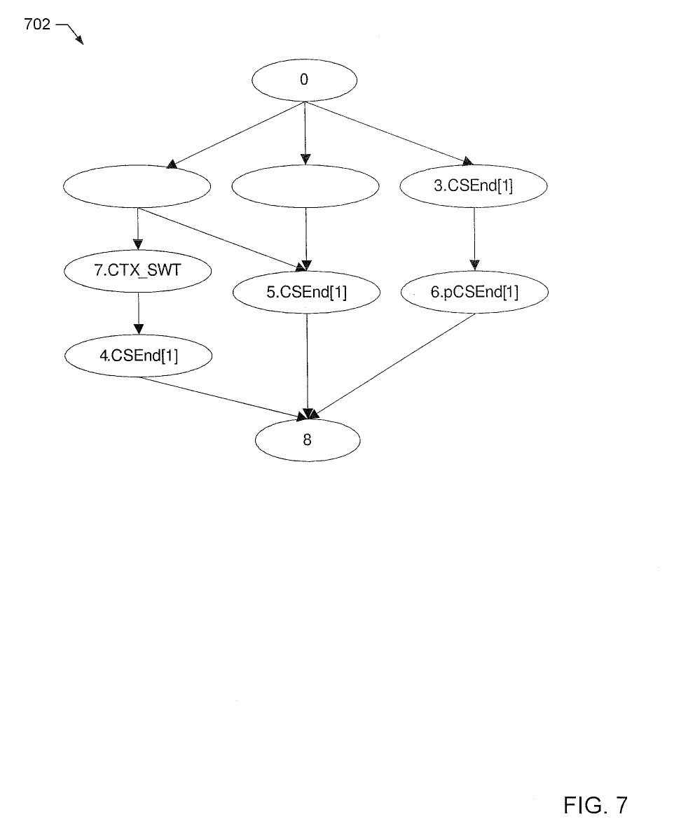

FIG. 7 is a flow diagram illustrating the result of the process 308 applied to the flow diagram 502 of FIG. 5. As previously described, the partition set corresponding to the context switching instruction in node 7 is {1 2 4 5}. Node 1 and node 2 in flow diagram 502 included CSend instructions that have been removed by the process 308. Node 4 and node 5 in flow diagram 502 included pCSend instructions that have been replaced with CSend instructions.

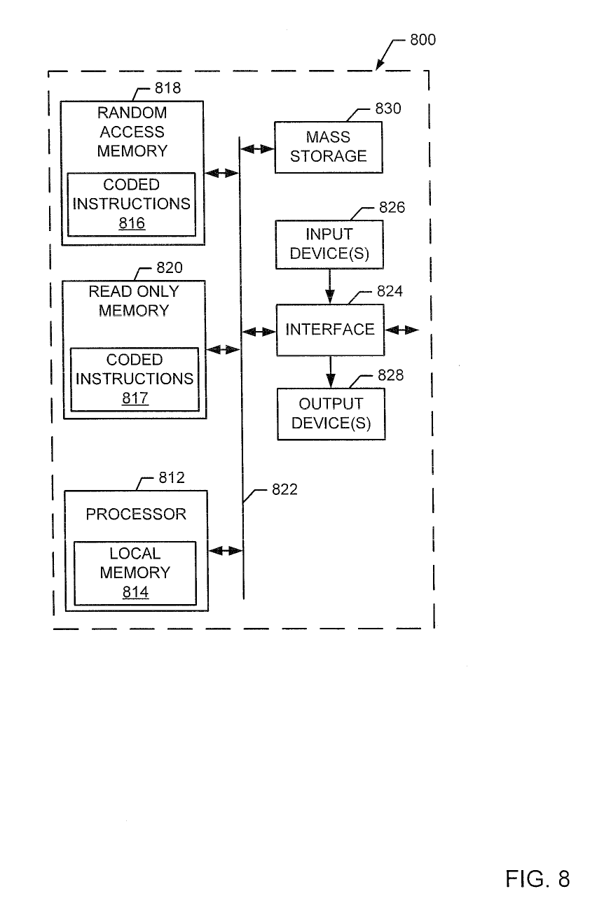

FIG. 8 is a block diagram of an example computer 800 capable of executing the machine readable implementing the processes illustrated in FIGS. 3, 4, and 6 to implement the apparatus and/or methods disclosed herein.

The system 800 of the instant example includes a processor 812 such as a general purpose programmable processor. The processor 812 includes a local memory 814, and executes coded instructions 816 present in random access memory 818, coded instruction 817 present in the read only memory 820, and/or instructions present in another memory device. The processor 812 may execute, among other things, machine readable instructions that implement the processes illustrated in FIGS. 3, 4, and 6. The processor 812 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 812 is in communication with a main memory including a volatile memory 818 and a non-volatile memory 820 via a bus 825. The volatile memory 818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown) in a conventional manner.

The computer 800 also includes a conventional interface circuit 824. The interface circuit 824 may be implemented by any type of well known interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, isopoint and/or a voice recognition system.

One or more output devices 828 are also connected to the interface circuit 824. The output devices 828 can be implemented, for example, by display devices (e.g., a liquid crystal display, a cathode ray tube display (CRT), a printer and/or speakers). The interface circuit 824, thus, typically includes a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives.

As an alternative to implementing the methods and/or apparatus described herein in a system such as the device of FIG. 7, the methods and/or apparatus described herein may alternatively be embedded in a structure such as processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to optimize computer instructions, the method comprising:
receiving a set of computer instructions;
determining a first location of a first computer instruction that indicates the end of a critical section in the set of computer instructions; and
modifying the execution order of the set of computer instructions to cause the first computer instruction to be executed earlier than the first location.

2. A method as defined in claim 1, wherein modifying the execution order comprises at least one of moving the first computer instruction to a second location prior to the first location or scheduling the first computer instruction to execute earlier than the first location.

3. A method as defined in claim 2, further comprising inserting a place holder at the first location.

4. A method as defined in claim 3, further comprising, after modifying the execution order of the set of computer instructions, removing the place holder.

5. A method as defined in claim 3, further comprising:
determining a data flow for the set of computer instructions;
determining a partition set corresponding to a context switching instruction in the set of computer instructions; and
when the place holder is in the partition set, removing the place holder and inserting a second computer instruction that indicates the end of the critical section at the first location.

6. A method as defined in claim 2, further comprising:
determining a third location of a context switching instruction in the set of computer instructions;
determining if the second location is prior to the third location;
when the second location is prior to the third location, removing the first computer instruction that indicates the end of the critical section; and
inserting a second computer instruction that indicates the end of the critical section at the first location.

7. A method as defined in claim 1, further comprising:
determining a data flow for the set of computer instructions;
determining a partition set corresponding to a context switching instruction in the set of computer instructions; and
when the first computer instruction that indicates the end of the critical section is in the partition set, removing the first computer instruction and inserting a second computer instruction that indicates the end of the critical section at the first location.

8. A method as defined in claim 7, further comprising removing a set including the first computer instruction that indicates the end of the critical section from the partition set.

9. An apparatus to optimize computer instructions, the method comprising:
an instruction receiver to receive a set of computer instructions; and
a critical section end notification hoister to determine a first location of a first computer instruction that indicates the end of a critical section in the set of computer instructions and to modify the execution order of the set of computer instructions to cause the first computer instruction to be executed earlier than the first location.

10. An apparatus as defined in claim 9, wherein modifying the execution order of the set of computer instructions comprises at least one of moving the first computer instruction that indicates the end of the critical section to a second location prior to the first location or scheduling the first computer instruction to execute earlier than the first location.

11. An apparatus as defined in claim 10, further comprising a pseudo critical end notification creator to insert a place holder at the first location.

12. An apparatus as defined in claim 10, further comprising a pseudo end remover to remove the place holder after moving the first computer instruction that indicates the end of the critical section.

13. An apparatus as defined in claim 10, further comprising a correctness verifier to determine a data flow for the set of computer instructions, to determine a partition set corresponding to a context switching instruction in the set of computer instructions, and when the place holder is in the partition set, to remove the place holder and insert a second computer instruction that indicates the end of the critical section at the first location.

14. An apparatus as defined in claim 10, further comprising a correctness verifier to determine a third location of a context switching instruction in the set of computer instructions; to determine if the second location is prior to third location; when the second location is prior to the third location, to remove the first computer instruction that indicates the end of the critical section; and to insert a second computer instruction that indicates the end of the critical section at the first location.

15. An apparatus as defined in claim 9, further comprising a correctness verifier to determine a data flow for the set of computer instructions; to determine a partition set corresponding to a context switching instruction in the set of computer instructions; and when the first computer instruction that indicates the end of the critical section is in the partition set, to remove the first computer instruction and insert a second computer instruction that indicates the end of the critical section at the first location.

16. An apparatus as defined in claim 15, wherein the correctness verifier is further to remove a set including the first computer instruction that indicates the end of the critical section from the partition set.

17. An article of manufacture storing machine readable instruction which, when executed, cause a machine to:
receive a set of computer instructions; and
determine a first location of a first computer instruction that indicates the end of a critical section in the set of computer instructions; and
modify the execution order of the set of computer instructions to cause the first computer instruction to be executed earlier than the first location.

18. An article of manufacture as defined in claim 17, wherein modifying the execution order comprises at least one of moving the first computer instruction that indicates the end of the critical section to a second location prior to the first location or scheduling the first computer instruction to execute earlier than the first location.

19. An article of manufacture as defined in claim 18, wherein the instructions further cause the machine to insert a place holder at the first location.

20. An article of manufacture as defined in claim 18, wherein the instructions further cause the machine to remove the place holder after moving the first computer instruction that indicates the end of the critical section.

21. An article of manufacture as defined in claim 18, wherein the instructions further cause the machine to:
determine a third location of a context switching instruction in the set of computer instructions;
determine if the second location is prior to third location;
remove the first computer instruction that indicates the end of the critical section when the second location is prior to the third location; and
insert a second computer instruction that indicates the end of the critical section at the first location.

22. An article of manufacture as defined in claim 17, wherein the instructions further cause the machine to:
determine a data flow for the set of computer instructions;
determine a partition set corresponding to a context switching instruction in the set of computer instructions; and
remove the place holder and insert a second computer instruction that indicates the end of the critical section at the first location when the place holder is in the partition set.

23. An article of manufacture as defined in claim 17, wherein the instructions further cause the machine to:
determine a data flow for the set of computer instructions;
determine a partition set corresponding to a context switching instruction in the set of computer instructions; and
remove the first computer instruction and insert a second computer instruction that indicates the end of the critical section at the first location when the first computer instruction that indicates the end of the critical section is in the partition set.

24. An article of manufacture as defined in claim 23, wherein the instructions further cause the machine to remove a set including the first computer instruction that indicates the end of the critical section from the partition set.
